(19) United States
(12) Patent Application Publication
(10) Pub. No.: US 2019/0040895 A1
(43) Pub. Date: Feb. 7, 2019

(54) Toggle Bolt

(71) Applicant: Engineered Supply LLC, Stillwater, MN (US)

(72) Inventor: Arlen Paul Grant, Stillwater, MN (US)

(73) Assignee: Engineered Supply LLC, Stillwater, MN (US)

(21) Appl. No.: 16/052,608

(22) Filed: Aug. 2, 2018

Related U.S. Application Data
(60) Provisional application No. 62/540,561, filed on Aug. 2, 2017.

(51) Int. Cl. F16B 13/08

(52) U.S. Cl. CPC F16B 13/0808

(57) ABSTRACT

In some embodiments, a fastener assembly is arranged to engage a supporting member. In some embodiments, the fastener assembly comprises a shaft, a first retaining member and a second retaining member. The first retaining member is arranged to engage the shaft, and is sized to pass through an opening in the supporting member in a first orientation and to abut a second side of the supporting member in a second orientation. The second retaining member is arranged to engage the shaft and to abut the first side of the supporting member.

### CROSS-REFERENCE TO RELATED APPLICATIONS

This application claims the benefit of U.S. Patent Application No. 62/540,561, filed Aug. 2, 2017, the entire content of which is hereby incorporated herein by reference.

### BACKGROUND OF THE INVENTION

This invention relates generally to fasteners and more specifically to a fastener system that can be installed from one side of a supporting surface.

Objects can be fastened together using a bolt and nut. Often, both sides of a connection are accessible, and the nut and the head of the bolt can both be engaged using tools.

In some instances, only one side of a connection is accessible to an installer. For example, in a building, when an installer is positioned on one side of a wall, the opposite side of the wall may not be accessible. Similar difficulties exist when attaching bolted connections to a floor or ceiling.

There remains a need for novel devices that provide the security of a bolted connection, which can be installed from one side of a supporting surface.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In some embodiments, a fastener assembly is arranged to engage a supporting member. In some embodiments, the fastener assembly comprises a shaft, a first retaining member and a second retaining member. The first retaining member is arranged to engage the shaft, and is sized to pass through an opening in the supporting member in a first orientation and to abut a second side of the supporting member in a second orientation. The second retaining member is arranged to engage the shaft and to abut the first side of the supporting member.

In some embodiments, a fastener comprises a shaft, a bar nut and a flange nut. In some embodiments, the shaft comprises a first threaded portion and a second threaded portion. In some embodiments, the bar nut comprises an elongate body, a first threaded aperture and a handle. The first threaded aperture of the bar nut is arranged to engage the first threaded portion of the shaft. In some embodiments, the flange nut comprises a second threaded aperture, a tubular portion and a flange extending outwardly from the tubular portion. The second threaded aperture is arranged to engage the second threaded portion and the tubular portion is arranged to surround the threaded shaft.

In some embodiments, a method comprises providing a first retaining member comprising a body having a length greater than a cross-sectional dimension. The first retaining member comprises a handle comprising a first portion attached to the body and a second portion. From a first side of a supporting member, the method comprises passing the body through an opening in the supporting member to orient the body on a second side of the supporting member while retaining the second portion of the handle on the first side. The method further comprises orienting a shaft through the opening and engaging the shaft with the first retaining member, and engaging a second retaining member with the shaft.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE DRAWINGS

A detailed description of the invention is hereafter described with specific reference being made to the drawings.

FIG. 1 shows embodiments of a toggle bolt fastener assembly.

FIG. 2 shows an embodiment of a toggle bolt fastener assembly.

FIG. 3 shows an embodiment of a toggle bolt fastener assembly with certain hidden features visible.

FIG. 4 shows an embodiment of a flange nut.

FIG. 5 shows an embodiment of a bar nut.

FIGS. 6-10 show example steps of a method of attaching a workpiece to a supporting surface using an embodiment of a toggle bolt fastener assembly.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

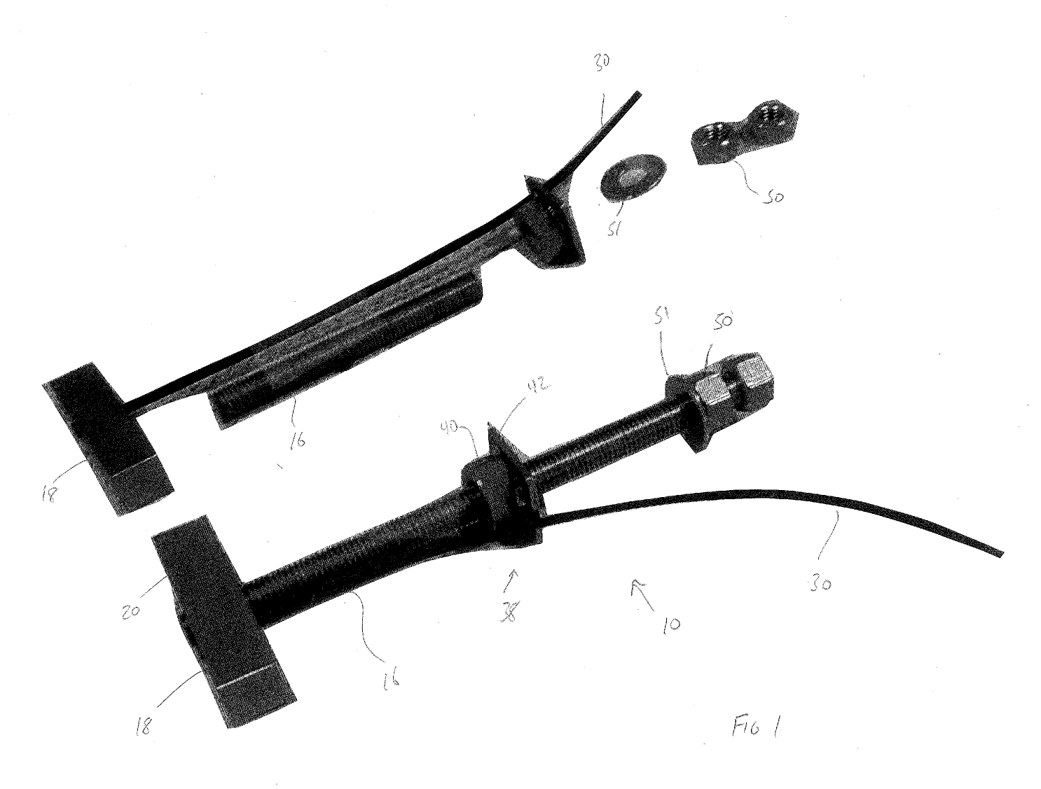

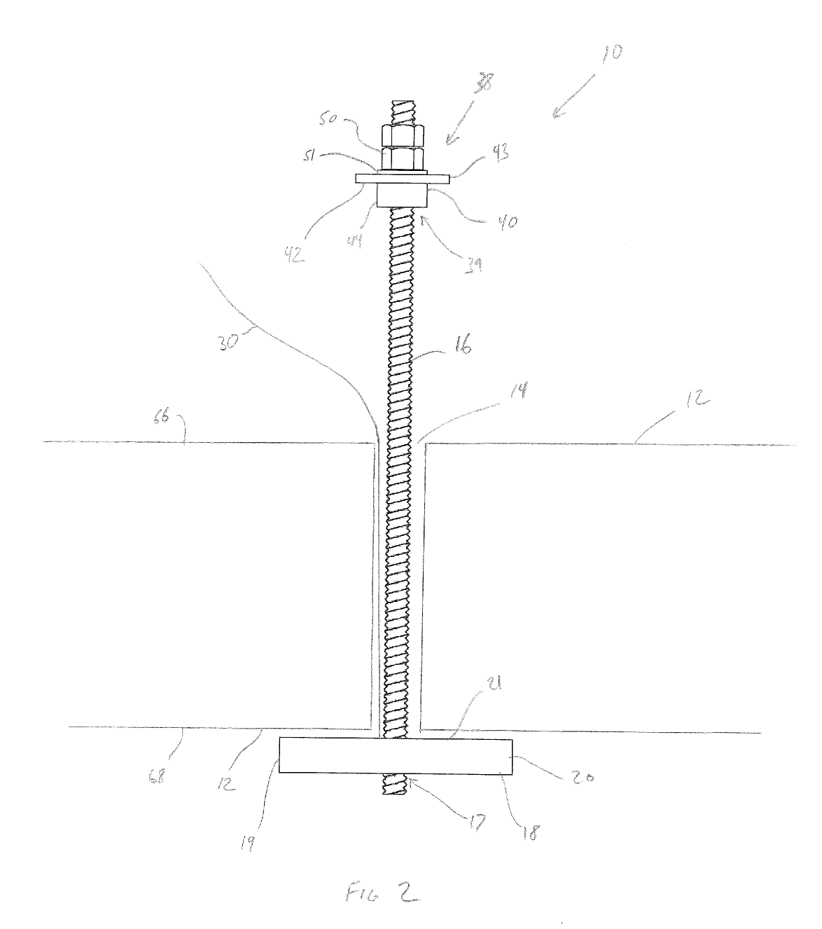

Referring to FIGS. 1-3, in some embodiments, a toggle bolt fastener assembly 10 comprises a shaft 16, a first retaining member 18, a handle 30 and a second retaining member 38. In some embodiments, the first retaining member 18 comprises the handle 30. Desirably, the shaft 16 is arranged to engage the first retaining member 18. In some embodiments, the shaft 16 comprises a first threaded portion 17 comprising helical screw threads, and the first retaining member 18 comprises a complimentary threaded portion 22 arranged to engage the first threaded portion 17. In some embodiments, an outer surface of the shaft 16 is threaded and the first retaining member 18 comprises a threaded aperture 22 that receives and engages the shaft 16.

In some embodiments, the first retaining member 18 comprises a toggle nut that can be delivered through an opening 14 in a supporting surface 12 in a first orientation and toggled to a second orientation where the first retaining member 18 spans across the opening 14 and abuts the supporting surface 12. In some embodiments, the first retaining member 18 comprises a cross-sectional area 19 that is less than the cross-sectional area of the opening 14, and a length that is greater than a distance across the opening 14.

In some instances, a first side 66 of the supporting surface 12 is accessible and a second side 68 of the supporting surface is not accessible. In some embodiments, the first retaining member 18 can be positioned in a first orientation and passed from the first side 66 through the opening 14 to the second side 68. A distal end 31 of the handle 30 can be retained on the first side 66 in order to hold and manipulate the first retaining member 18. The first retaining member 18 can be repositioned to a second orientation where the body of the first retaining member 18 spans across the opening 14 and abuts the second side 68 of the supporting surface 12. The shaft 16 can be inserted through the opening 14 and attached to the first retaining member 18, for example by engaging screw threads.

In some embodiments, the first retaining member 18 comprises a bar 20 comprising a length that is greater than a distance across the opening 14 and a width and height that are each less than a distance across the opening. In some embodiments, the width and height define the cross-sectional area 19 that can pass through the opening 14. In some embodiments, the first retaining member 18 comprises a flat surface 21 arranged to abut the supporting surface 12.

The handle 30 can be attached to the first retaining member 18 in any suitable way, for example with a fastener or adhesive (not shown). In some embodiments, the first retaining member 18 comprises an aperture 26 that receives the handle 30. In some embodiments, the handle aperture 26 is offset from the threaded aperture 22. In some embodiments, the aperture 26 comprises a first portion 27 and a second portion 28, and the second portion 28 is sized differently from the first portion 27. In some embodiments, a flange is created between the first portion 27 and the second portion 28. In some embodiments, the handle 30 comprises an enlarged portion 32 that can be oriented in the second portion 28 but cannot enter the first portion 27, and the enlarged portion 32 can be wedged in the aperture 26. Desirably, the handle 30 is suitable for holding the first retaining member 18 against a supporting surface 12.

In some embodiments, the second retaining member 38 is arranged to engage the shaft 16. In some embodiments, the shaft 16 comprises a second threaded portion 39 comprising helical screw threads, and the second retaining member 38 comprises a complimentary threads arranged to engage the second threaded portion 39. In some embodiments, an outer surface of the shaft 16 is threaded and the second retaining member 18 comprises internal threads arranged to engage the second threaded portion 39.

In some embodiments, the second retaining member 38 comprises a simple nut. In some embodiments, the second retaining member 38 comprises a flange nut 40 comprising a flange 42 arranged to abut a supporting surface 12. In some embodiments, the flange 42 comprises a dimension that is greater than a distance across the opening 14. In some embodiments, the flange 42 comprises an area that is greater than a cross-sectional area of the opening 14. In some embodiments, the flange 42 comprises flat sides that comprise wrench flats 43. In some embodiments, the flange 42 comprises a square shape.

In some embodiments, the second retaining member 38 comprises a tubular portion 44. In some embodiments, the tubular portion 44 is fixedly attached to the flange 42. In some embodiments, the tubular portion 44 comprises an internal cavity that receives the shaft 16. In some embodiments, a distance across the tubular portion 44 is less than a distance across the opening 14, and the tubular portion 44 fits into the opening. In some embodiments, the tubular portion 44 acts as a spacer that helps to center the shaft 16 in the opening 14 and center the flange 43 across the opening 14.

In some embodiments, the toggle bolt assembly further 10 comprises a washer 51 and one or more nuts 50.

FIG. 4 shows an embodiment of a second retaining member 38 comprising a flange 43 and a spacer 44. In some embodiments, the flange 43 comprises internal threads 46. As shown in FIG. 4, in some embodiments, the threads 46 are formed in the flange portion 42 but do not extend into the tubular portion 44 of the flange nut 40. In some embodiments, the threads 46 extend an entire length of the second retaining member 38.

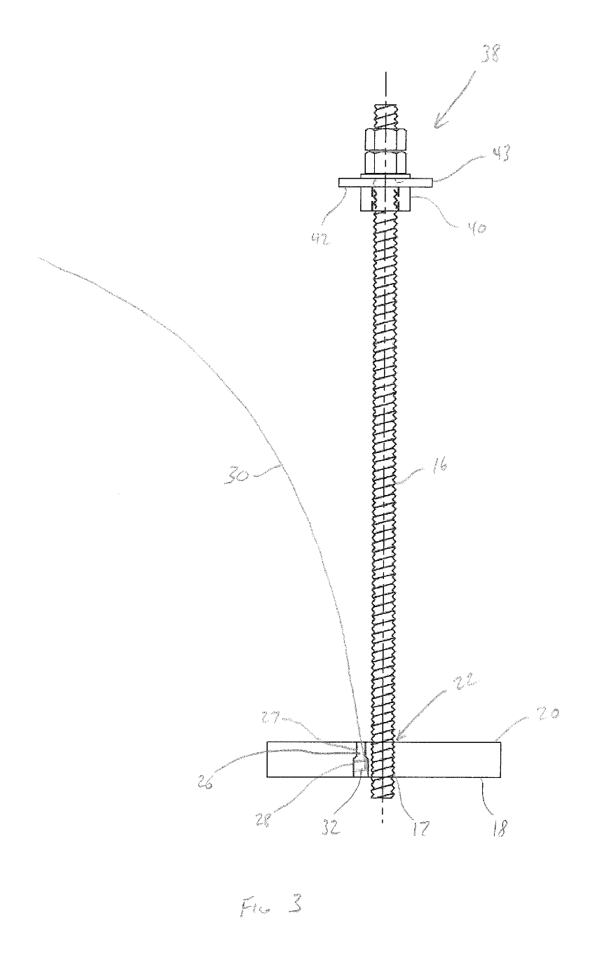

FIG. 5 shows an embodiment of a first retaining member 18. In some embodiments, the threaded aperture 22 is centered along a length of the first retaining member 18. In some embodiments, the handle aperture 26 is not centered along a length of the first retaining member 18. In some embodiments, the handle aperture 26 is located adjacent to the threaded aperture 22. In some embodiments, a total distance across the threaded aperture 22 and handle aperture 26 is less than a distance across the opening 14. In some embodiments, the total distance across the threaded aperture 22 and handle aperture 26 is less than a distance across the spacer 44.

FIGS. 6-10 show various steps of an embodiment of a method of installing a toggle bolt assembly 10 from one side of a supporting surface 12. In FIG. 6, a supporting surface 12 is shown having a horizontal orientation. In some embodiments, a supporting surface 12 comprises a floor.

An opening 14 can be formed in the supporting surface 12, allowing access to the second side 68. FIG. 6 shows an embodiment of a first retaining member 18 comprising a bar 20 being fed through the opening 14. Desirably, a cross-sectional size and shape of the first retaining member 18 is smaller than the opening 14, allowing the first retaining member 18 to be fed from the first side 66 of the supporting surface 12 through the opening 14 to the second side 68 while the first retaining member 18 is in a first orientation. Desirably, a portion of the handle 30 is retained on the first side 66 of the supporting surface 12, so the first retaining member 18 can be held and repositioned.

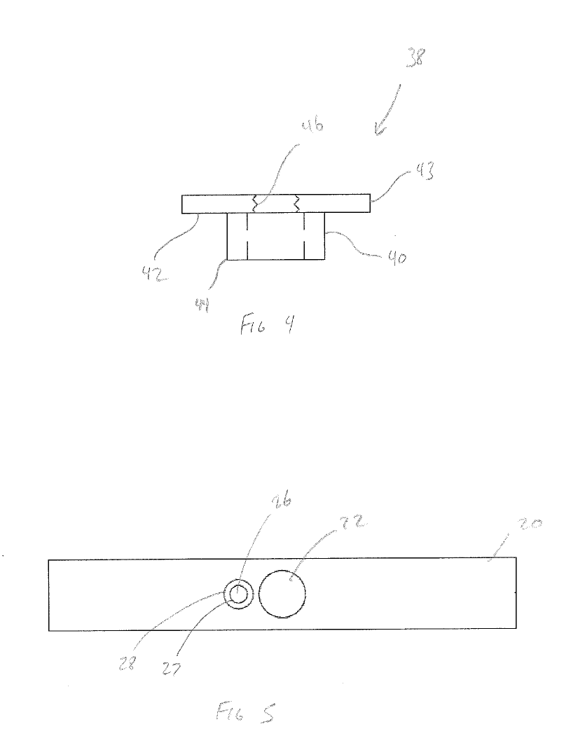

FIG. 7 shows the first retaining member 18 after fully passing through the opening 14 and becoming positioned on the second side 68 of the supporting surface 12. The handle 30 extends through the opening 14 and allows the first retaining member 18 to be supported from the first side 66 of the supporting surface 12. An orientation of the first retaining member 18 can be toggled to a second orientation where the first retaining member 18 cannot pass through the opening 14. In some embodiments, a length of the first retaining member 18 is greater than a distance across the opening 14, and the first retaining member 18 will abut the second side 68 of the supporting surface 12 on opposite sides of the opening 14.

FIG. 8 shows the handle 30 being used to support the first retaining member 18 while the shaft 16 is being engaged to the first retaining member 18. In some embodiments, the shaft 16 is turned with respect to the first retaining member 18, causing screw threads to engage one another.

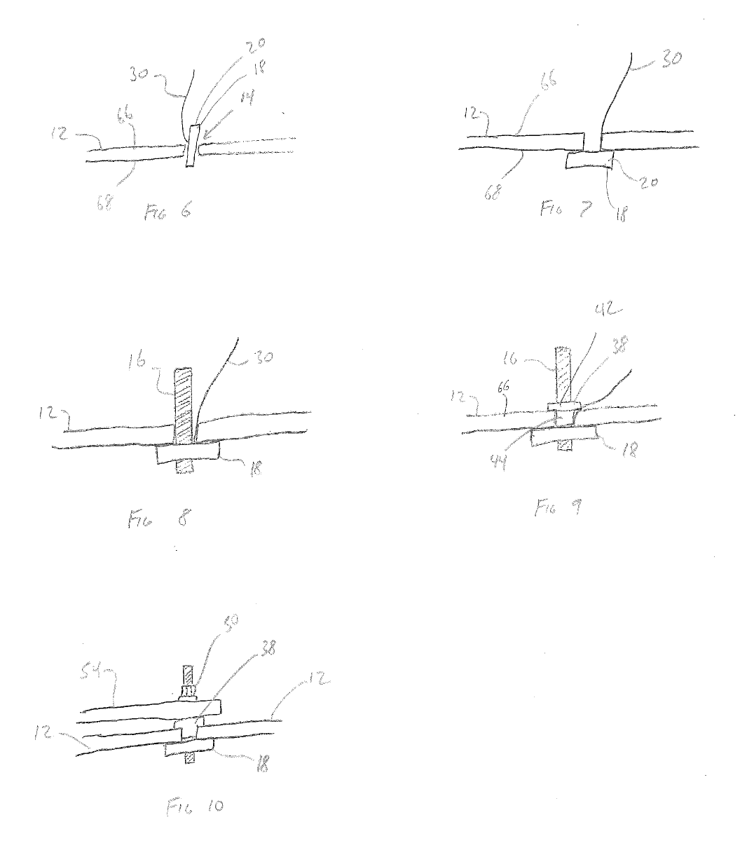

FIG. 9 shows the second retaining member 38 threaded onto the shaft 16. In some embodiments, the second retaining member 38 is oriented such that the flange 42 abuts the first side 66 of the supporting surface 12 and the spacer portion 44 extends into the opening 14. In some embodiments, the spacer portion 44 of the second retaining member 38 is sized to snugly engage the opening 14. In some embodiments, wrench flats 43 on the second retaining member 38 allow the second retaining member 38 to be tightened. As shown in FIG. 9, the first retaining member 18, shaft 16 and second retaining member 38 form a fastener that engages the supporting surface 12. At this point the handle 30 can be removed, if desired.

A workpiece 54 can then be attached to the toggle bolt 10. In some embodiments, a workpiece 54 comprises a construction anchor. In some embodiments, the shaft 16 can be oriented though an aperture in the workpiece 54, and a nut 50 can be used to engage the shaft 16. The nut 50 can be tightened such that the nut 50 and flange nut 40 secure the workpiece 54. The toggle bolt 10 securely attaches the workpiece 54 to the supporting surface 12 while only requiring access from one side of the supporting surface.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A fastener arranged to engage a supporting member, the fastener comprising:
a shaft;
a first retaining member arranged to engage the shaft, the first retaining member sized to pass through an opening in the supporting member in a first orientation and to abut a first side of the supporting member in a second orientation; and
a second retaining member arranged to engage the shaft and to abut a second side of the supporting member.

2. The fastener of claim 1, the second retaining member comprising a first portion and a second portion, the first portion arranged to engage the second side of the supporting member, the second portion arranged to extend into the opening.

3. The fastener of claim 2, the second portion comprising a tubular shape.

4. The fastener of claim 2, the second portion comprising a circular cross-sectional shape.

5. The fastener of claim 1, the first retaining member comprising a handle.

6. The fastener of claim 5, the first retaining member comprising an aperture, a portion of the handle oriented in the aperture.

7. The fastener of claim 6, the aperture having a first portion and a second portion, the second portion having a larger cross-sectional shape than the first portion.

8. The fastener of claim 6, the handle comprising a zip tie.

9. The fastener of claim 1, the first retaining member comprising an elongate shape.

10. The fastener of claim 1, further comprising a third retaining member arranged to engage the shaft.

11. The fastener of claim 10, wherein the second retaining member and the third retaining member are arranged to engage a workpiece.

12. A fastener arranged to engage a supporting member, the fastener comprising:
a shaft comprising a first threaded portion and a second threaded portion;
a bar nut comprising an elongate body, a first threaded aperture and a handle, the first threaded aperture arranged to engage the first threaded portion; and
a flange nut comprising a second threaded aperture, a tubular portion and a flange extending outwardly from the tubular portion, the second threaded aperture arranged to engage the second threaded portion, the tubular portion arranged to surround the threaded shaft.

13. The fastener of claim 12, further comprising a washer and a nut arranged to engage the shaft.

14. The fastener of claim 12, the handle comprising an elongate body, a longitudinal axis of the elongate body oriented parallel to a central axis of the first threaded aperture.

15. The fastener of claim 12, the flange comprising a square shape.

16. The fastener of claim 12, the bar nut comprising a cross-section sized to fit through an opening in the supporting member, the bar nut comprising a length greater than a distance across the opening.

17. The fastener of claim 16, wherein a distance across the flange is greater than the distance across the opening.

18. The fastener of claim 17, the tubular portion sized to fit into the opening.

19. A method comprising:
providing a first retaining member comprising a body having a length greater than a cross-sectional dimension, the first retaining member comprising a handle, the handle comprising a first portion attached to the body and a second portion extending away from the body;
passing the body through an opening in the supporting member to orient the body on a second side of the supporting member while retaining the second portion of the handle on a first side of the supporting member;
orienting a shaft through the opening and engaging the shaft with the first retaining member; and
engaging a second retaining member with the shaft.

20. The method of claim 19, wherein said passing the body comprises arranging the body in a first orientation as it passes through the opening and arranging the body in a second orientation to abut the second side of the supporting member.
